(19) United States
(12) Patent Application Publication
(10) Pub. No.: US 2010/0227149 A1
(43) Pub. Date: Sep. 9, 2010

(54) MICROFOAM AND ITS MANUFACTURING METHOD

(76) Inventors: Ki-Nam Koo, Seoul (KR); Shushi Kitamura, Kobe (JP)

Correspondence Address: CHRISTIE, PARKER & HALE, LLP, PO BOX 7068, PASADENA, CA, 91109-7068, US

(21) Appl. No.: 12/400,377

(22) Filed: Mar. 9, 2009

(51) Int. Cl. B32B 3/26; B29C 44/04; B29C 47/00; C08J 9/22

(52) U.S. Cl. 428/304.4; 264/45.1; 264/45.9; 425/378.2; 521/56

(57) ABSTRACT

Foamed materials, and methods and systems of producing the same. At least one of the methods includes forming a composite material including paper powder having a maximum particle size between about 30 to about 100 μm 30 and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material; and forming the foamed material from the composite material by producing an abrupt expansion of vapor in the composite material.

### FIELD

Foams, their manufacturing methods, and systems of producing the same are discussed herein.

### BACKGROUND

Polymer foamed materials have high thermal insulating properties and are useful in various applications. They are frequently used as construction, packaging, buffer, or lagging materials. However, polymer foamed materials generate great bulk upon discarding, thereby increasing the volume of landfill. Additionally, conventional polymer foamed materials are not biodegradable or undergo slow degradation processes in the natural environment. Accordingly, conventional polymer foamed materials may remain in the soil for a long period of time when disposed underground. When conventional polymer foamed materials are incinerated as an alternative to landfill deposit, the polymer foamed materials generate high heat or enthalpy, thereby often causing damage to the incinerators. In particular, soot and toxic gases generated from the polymer while it is being burned or incinerated have to be properly evacuated or they pose dangerous health problems. Therefore, various efforts in developing foams that are both biodegradable and heat resistant have been studied and continued to develop over recent years.

Recent development includes providing foams having paper as one of the major components of the foam composition to make the foamed material biodegradable. Other materials such as starch, thermoplastic powder, such as polypropylene, and fibers can also be used to make the foams biodegradable. Water is also added as an additive to the foamed composition or downstream in an extruding process to provide a wet composite. The wet composite is heated and kneaded in an extruder cylinder, and foamed due to the evaporation of water inside the extruder cylinder.

However, conventional foamed materials made from the mixture of paper, starch, thermoplastic polymer resin, and water by extrusion is mostly made to function as a buffer (or pellets) for packaging applications. These conventional foamed materials cannot be used easily for large applications because they are formed from a single strand die. As a result, conventional foamed materials have weak foaming performance, uneven cross-section areas, low insulation, and weak strength.

### SUMMARY OF THE INVENTION

Aspects of embodiments of the present invention are directed toward foamed materials (e.g. foamed materials having strands embedded therein,) and methods and systems of producing the same.

In an embodiment, a method of forming a foamed material is provided. The method includes forming a composite material composed of paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material; and forming the foamed material from the composite material by producing an abrupt expansion of vapor in the composite material.

The composite material may further include an antioxidant being between about 0.1 and about 3.0 weight % of the composite material, boric acid being between about 1.0 and 10.0 weight % of the composite material, and a UV absorbent being between about 1.0 and 10 weight % of the composite material to enhance the performance of the foamed material.

The composite material may further include a calcium carbonate or sodium stannic acid material being between about 0.5 to about 15.0 weight % of the composite material. The addition of the calcium carbonate or stannic acid material imparts finer structures and a smooth cross-section area for the foamed material. This will improve the buffer and insulation characteristics of the foamed material. In one embodiment, the composite material includes a basic micro powder having a pH between about 8 and 14 and being between about 0.2 and 5.0 weight % of the composite material. The basic micro powder may be selected from the group consisting of fired shells, sodium hydrates, sodium stannic acids, and combinations thereof.

In one embodiment, gas pressure in the extruder cylinder is increased by carbonate gas that is generated from the vapor solution. The vapor solution includes water and may include an alcohol. In one embodiment, the alcohol is between about 3 and about 30 weight % of the vapor solution. In another embodiment, the alcohol is between about 8 and about 35 weight % of the vapor solution.

In one embodiment, the method of producing a foamed material includes injecting the composite material through an extruder, and heating and kneading the composite material in an enclosed extruder cylinder at a forming temperature between about 155 to 195° C.; and extruding and foaming a plurality of strands from the composite material out of the extruder along one direction under pressure from holes in a die of the extruder. The foamed strands are produced from an abrupt expansion of the vapor in the composite material. The foamed material is formed when the foamed strands are fused together by latent heat (or heat that is still remained in the foamed strands).

The foamed materials may be provided in different shapes by utilizing different dies. In one embodiment, the die has a plurality of holes with a hole size between about 1.0 and about 3.5 mm on a first side of the die, and a length between about 3.0 to about 10 mm from a second side of the die to the first side of the die. In one embodiment, the centers of the holes on the first side of the die are separated from each other by a distance between about 4.0 and about 20 mm.

Another embodiment of the present invention provides a foamed material. The foamed material is produced from a composite material, which includes paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material.

In one embodiment, the foamed material includes a plurality of foamed strands extending along one direction. The composite material is kneaded with an extruder (e.g. extruder blade) to form a dough. The dough is extruded under pressure through holes in a die of the extruder into the plurality of foamed strands along the one direction. The plurality of foamed strands have foamed cells forming therein, which are formed by an abrupt expansion of vapor in the composite material, and the plurality of foamed strands are fused together at their contact points to produce the foamed material.

In one embodiment, the composite material for forming foamed materials includes paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material.

The composite material may further include an antioxidant being between about 0.1 and about 3.0 weight % of the composite material, boric acid being between about 1.0 and 10.0 weight % of the composite material, and a UV absorbent being between about 1.0 and 10 weight % of the composite material. In addition, the composite material can include a calcium carbonate or sodium stannic acid material being between about 0.5 to about 15.0 weight % of the composite material to increase pressure in the extruder by generating gas as at least a portion of the vapor. When a calcium carbonate or sodium stannic acid material is used, carbonated gas is generated. The vapor solution includes water and optionally alcohol. Alcohol may be included at between about 3 and about 30 weight % of the vapor solution, or more specifically, at between about 8 and about 35 weight % of the vapor solution.

In one embodiment, the composite material includes a basic micro powder having a pH between about 8 and 14. Nonlimiting examples of suitable basic micro powders include fired shells, sodium hydrates, sodium stannic acids, and combinations thereof. In one embodiment, the basic micro powder is at between about 0.2 and 5.0 weight % of the composite material. The composite material may further include a plant fiber having a length between about 50 and about 300 μm and a thickness between about 10 and about 30 μm. The plant fiber may be selected from the group consisting of wood, trunk or fruit core of sugar cane, rice stem, barley trunk, and combinations thereof.

### BRIEF DESCRIPTION OF THE DRAWINGS

FIG. 1 is a schematic of a block of foamed material according to an embodiment of the present invention;

FIG. 2 is a schematic of a block of foamed material including foamed strands according to an embodiment of the present invention;

FIG. 3 is a schematic of a process of producing the foamed material according to an embodiment of the present invention;

FIG. 4 is a cross-sectional view of a die of an extruder according to an embodiment of the present invention;

FIG. 5 is a schematic of a perspective view of the tip of an extruder and a manufactured foam block according to an embodiment of the present invention;

FIG. 6 is a schematic view of an arrangement of holes of a die according to an embodiment of the present invention;

FIG. 7 is a schematic view of an arrangement of holes of a die according to another embodiment of the present invention;

FIG. 8 is a schematic view of an arrangement of holes of a die according to yet another embodiment of the present invention;

FIG. 9 is a partial cross sectional view of a foam material being expelled through holes of a die according to an embodiment of the present invention; and

FIGS. 10A and 10B are illustrations of foam strands and air pockets included therein according to an embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Biodegradable foamed materials and processes for producing the same are described below in more detail. A biodegradable foamed material according to an embodiment of the present invention contains paper powder, starch, and a biodegradable resin as a major component or a main portion of a foam composite. Additives can be used to improve the strength and performance of the foamed materials. Nonlimiting examples of suitable additives include antioxidant, boric acid, UV absorbent, calcium carbonate, and sodium stannic acid.

In one embodiment, fine paper powder is being made from grinding old recycled paper. Suitable starch powders may include potato, sweet potato, corn, rice, wheat, taro, tapioca, modified, or processed powders. Suitable polypropylene resins may include block polymerized polypropylene, randomly polymerized polypropylene, homogenously polymerized polypropylene, metallocene catalyst polypropylene, and denaturalized polypropylene.

In one embodiment, water is used as a vapor solution, although alcohol can be used to facilitate the vaporization process. Further additives, such as antioxidant, boric acid, and UV absorbent can be used to further improve the foamed material characteristics. Antioxidants are used to protect (or prevent) the foamed material from degradation over time and to ensure long-term usage. In addition, boric acid can be used and added to composite material to provide bug-repellent (or moth-proof) effects, such as termite repellent, for example. The addition of the UV absorbent to composite material improves resistance to strong UV radiation from sunlight.

In one embodiment, the composite material includes about 20 to about 40 wt % paper powder, about 20 to about 40 w % starch powder, about 30 to about 49.5 wt % polypropylene resin, and about 10 to about 20 wt % vapor solution. In another embodiment, about 0.1 to about 3.0 wt % antioxidant, about 1.0 to about 10 wt % boric acid, and about 0.2 to about 3.0 wt % UV absorbent are added to the composite material.

Calcium carbonate or sodium stannic acid can be added to improve the vapor pressure in the extruder cylinder. In particular, when the calcium carbonate or sodium stannic acid is added at a desired temperature, carbonate gas is generated. The higher the vapor pressure, the finer the microstructure of the foamed material will be created. Fine foam microstructures impart a smooth cross-sectional structure and improve the buffer and insulation properties of the foamed materials. Accordingly, the foamed materials of various embodiments of the present invention can be used in a number of applications. In one embodiment, about 0.5 to about 15 wt % of calcium carbonate or sodium stannic acid is added to the foam composite to improve the foam-forming process during extrusion.

Water or an alcoholic solution is typically added in a hopper or an extruder feed along with the foam composite to form the wet mixture of composite material and to form vapors. Alternatively, water can be introduced to the foam composite in an extruder cylinder located down stream in the process. As the wet mixture is heated and kneaded along the extruder cylinder, water evaporates and produces water vapor, which aids in foam formations. The amount of water can be determined based on the desired degree of foaming. In one embodiment, the amount of water is adjusted until a sufficient vapor pressure is attained to form a desired internal foaming structure, but not more water than necessary so that there is not any residual water left after extrusion.

In another embodiment, alcohol is added to the water to form a vapor solution. The amount of alcohol may be between about 8 and about 35 wt % based on the total weight of alcohol and water, or more specifically, between about 3 and about 30 wt %.

Basic compounds having a pH value of about 8 to 14 can be added to the composite to enhance gas pressure during extrusion. The basic compounds improve the texture of the foamed material and increase the pH of the foamed materials. Accordingly, the foamed materials become neutral or alkali thereby imparting antifungal characteristics. Nonlimiting examples of suitable basic compounds include fine powders from fired shell, sodium hydrate, and sodium stannic acid. The basic compounds can be combined as a mixture and added to the foam composite at 0.2 to 5 wt %.

Plant fibers may be added to provide bulk and as fillers to the composite material. In addition, plant fibers can facilitate an increase in the biodegradability, bactericidal, and heat resistance characteristics of the foamed materials. Almost any parts of the plant, particularly, plant seeds, leaves, stems, stocks, or skins can be used as the plant fibers. In certain embodiments, plant wastes such as seed husks or left-over of the extracts can also be used. Nonlimiting examples of suitable plant wastes include husks of grain kernels of rice, wheat, buckwheat, soybeans, coffees, and peanuts; or fruit skin of chestnuts, oranges, apples, pears, etc., and fruit residues thereof. Other nonlimiting examples of suitable plant fibers include wood, trunk, or fruit of sugar canes, rice stems, barley trunks, and combinations thereof.

The plant fibers can be processed or modified to a set or desirable size range. Fine fibers can be used so that they can serve as nuclei for foaming to develop. Starch and polypropylene grow on the nuclei and form bubbles enclosing the nuclei, thereby improving the strength of the foamed material. In one embodiment, the plant fibers have an average length between about 50 and about 300 μm, and/or an average thickness (or diameter) between about 10 and about 30 μm. In another embodiment, the plant fibers have a maximum length between about 50 and about 300 μm, and/or a maximum thickness (or diameter) between about 10 and about 30 μm.

Fine paper powder and starch can also be used to further achieve a fine and consistent foam structure. In one embodiment, the composite material includes paper powder having a maximum particle size (or diameter) between 30 and 100 μm and starch powder having a maximum particle size (or diameter) between 5 and 30 μm.

The composite material is heated, mixed, and kneaded in an extruder, and extruded through a die having numerous holes under pressure. As the composite material is heated in the extruder cylinder and propelled forward by extruding blades, the vapor solution evaporates and builds up pressure within the extruder cylinder. The pressure also aids in pushing the composite material forward through and out of the die. Upon exiting the extruder cylinder, the composite material is exposed to the atmosphere that causes the composite material to experience an abrupt pressure drop, thereby causing the vapor to expand and creating the foam structure.

The die includes a plurality of holes so that strands of foamed materials can be created. In a continuous extruding process, as strands of foamed material are formed and pushed out of the die they contact each other and are bonded together to produce an integrated foamed material by latent heat (or because these foamed strands are still latent with heat.)

Methods and/or systems for producing foamed materials will now be described in more detail.

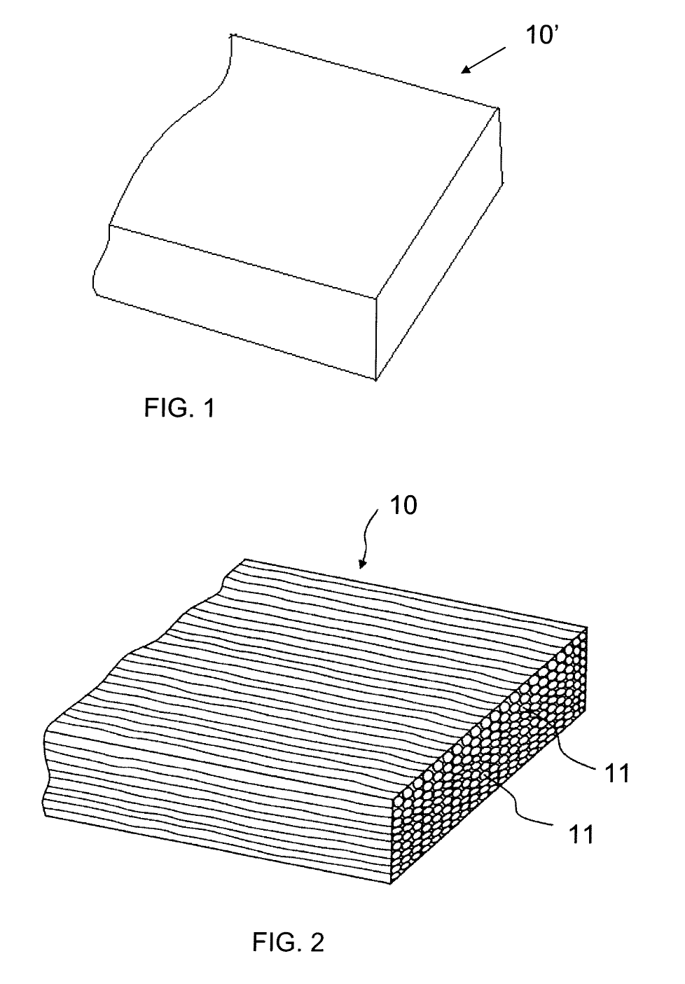

Referring to FIG. 1, a block of foamed material 10′ is shown. The foamed material 10′ is formed using an extruding process with a die that creates a cubical foamed material 10′ or block. Although the foamed materials of various embodiments of the present invention are produced with an extruder, other methods can be used. For example, the major component or foam composite can be heated and kneaded without the use of an extruder. Instead, the foam composite with an optional amount of water is heated and placed in a mold to provide a block shaped foamed material 10′ with no foamed strands (FIG. 1).

Referring to FIG. 2, a block of foamed material 10 having foamed strands 11 is shown. The foamed material 10 is formed using an extruding process with a special die that creates a plurality of strands 11 within the foamed material 10 or block. The foamed strands 10 are generally parallel to each other in a longitudinal direction. Each foamed strand has small bubbles formed therein.

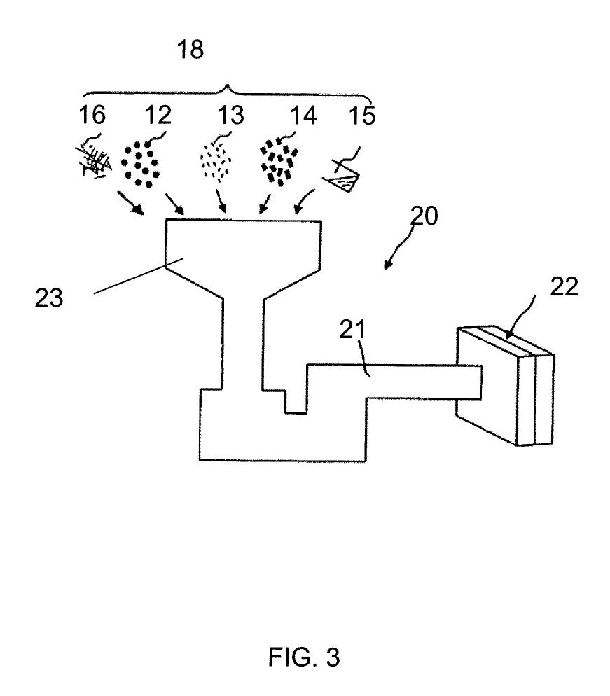

Referring to FIG. 3, in one embodiment, the plant fibers 16 are obtained by drying and crushing fibrous materials such as sugar cane parts to have a maximum thickness (or particle diameter) of 300 μm or less and preferably of 30 μm or less by ball milling or the like. The plant fibers 16 along with paper powders 12, starch 13, water as a vapor solution 15, and polymer resin 14 form a composite material (or major component) 18. The composite material 18 is heated and kneaded through a 2-axis cylinder 21, and extruded from a die portion 22 of the extruder 20. In one embodiment, the extruder is heated to a temperature of about 155 to about 195° C., thereby inducing water or vapor from the vapor solution to evaporate. The vapor produced from the vapor solution in the process aids in the formation of foams. The material produced from the die 22 is foamed and forms a block of foamed material 10 with foamed strands 11 forming therein (FIG. 1). The type of foamed material having foamed strands can be provided using different dies 22. The foamed strands 11 can be provided in different diameter sizes depending on the types of die 22 selected.

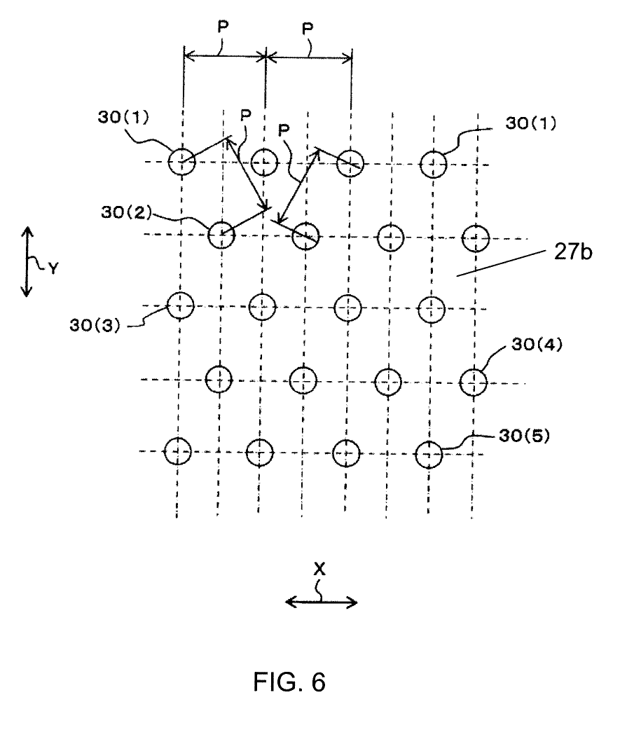

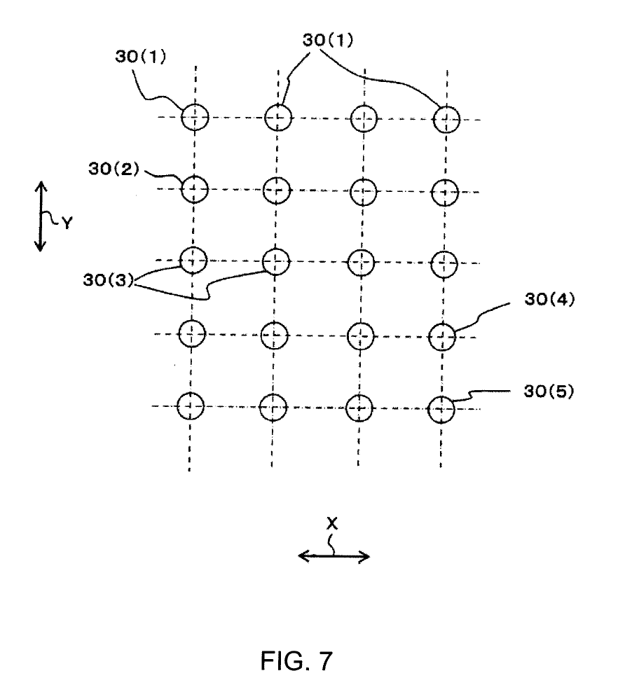

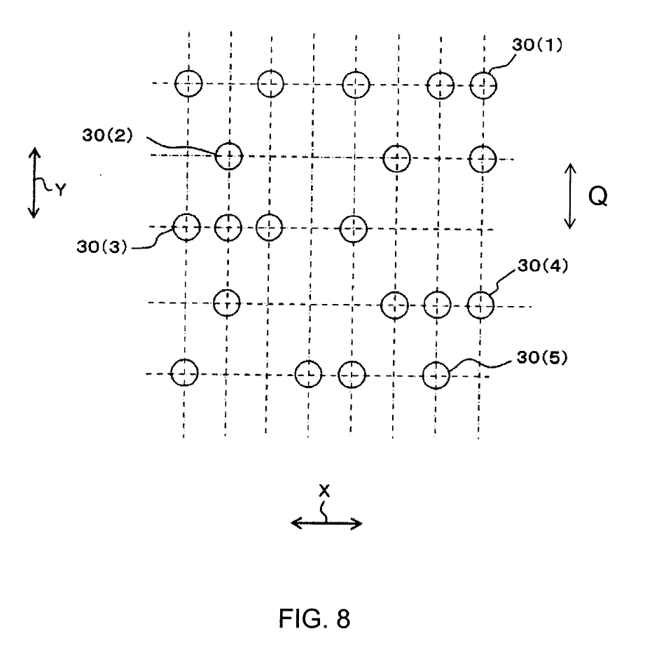

In one embodiment, the die 22 has holes having a diameter of about 1.0 to about 3.5 mm, and a length of about 3.0 to about 10 mm. The holes may be spaced at a holes-separation distance or a pitch (P) from each other (FIG. 6). In one embodiment, the holes separation distance (P) is between 4.0 to 2 mm. The holes can be aligned in rows such that they are parallel to each other (FIG. 7), each row has holes that offset the holes of the adjacent row by a distance (P/2) for instance (FIG. 6), or the holes can be randomly arranged as shown in FIG. 8. As shown in FIG. 8, each row is spaced apart by a fixed distance (Q). It is to be understood that the row distances can vary so that the holes can be arranged in a total random fashion.

Referring back to FIG. 3, a 2-axis extruder 20 includes a hopper 23, an extruder cylinder 21, and a die 22. Even though only one hopper 23 is shown, the extruder 20 can include multiple hoppers for storing a major component of the foam composite, which includes paper powder, starch, and a biodegradable resin, additives such as antioxidants, UV absorbents, calcium carbonate and/or sodium stannic acid, basic fine powders, and a vapor solution.

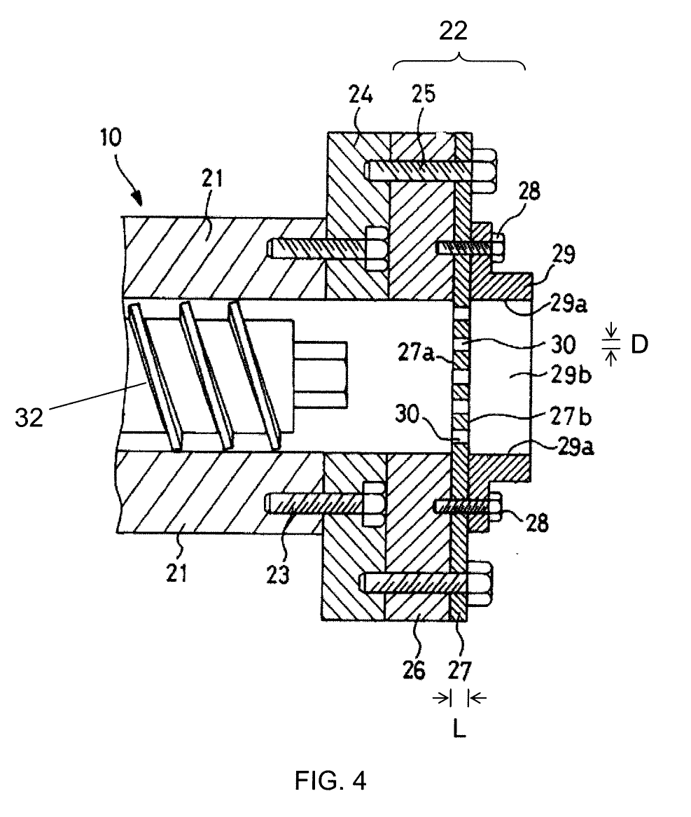

Referring to FIG. 4, a tip of the extruder 20 is shown, which includes a die 22 affixed to the extruder cylinder 21. The die 22 is affixed to an attachment (or attachment adapter) 24 with bolts 25. The attachment 24 is affixed to the extruder cylinder 21 with bolts 23 so that the die 22 can be independently removed and replaced easily. The die 22 includes a base 26, a hole plate 27, and a flange 29 having an internal surface 29a. The flange 29 is affixed to the hole plate 27 with bolts 28. The hole plate 27 is affixed to the base 26 via bolts 25. Even though the exemplary embodiment shows various components of the die 22 affixed to the extruder cylinder 21 using bolts, the components can be cast in one piece or affixed to the cylinder using other suitable mechanisms, such as welding, for example.

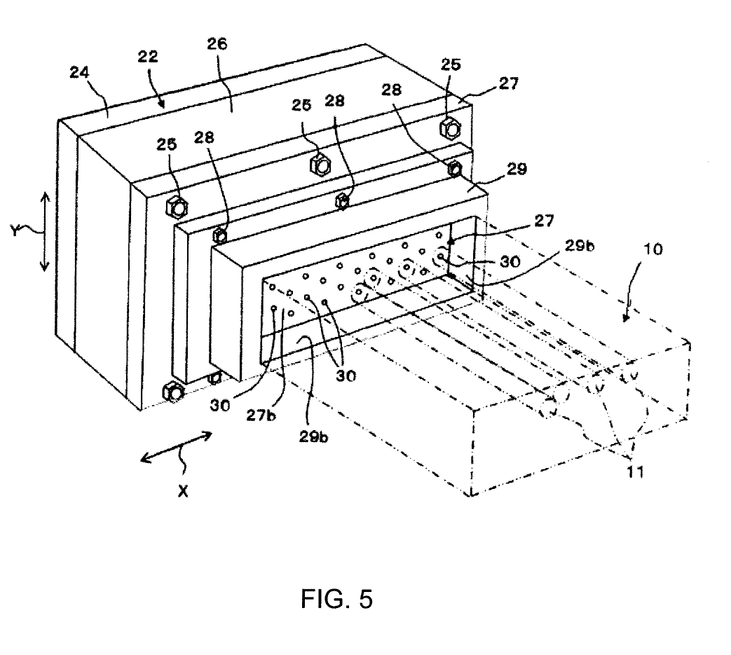

The hole plate 27 has multiple holes 30 to allow the composite material 18 to push through by an extruder screw 32. Each of the holes 30 has a length (L), and a diameter (D) that forms a molding passage 29b having an internal surface 27a within the hole plate 27. In one embodiment, the molding passage 29b has a hollow cylindrical body. The holes 30 are spaced apart such that there is a solid plate area 27b between the holes. In one embodiment, the internal surface 27a includes or is coated with Teflon resin to prevent (or protect) the internal surface 27a from being carbonized or degraded by shielding the surface from the high temperature of the composite material 18, which could be as high as 190° C. In one embodiment, the temperature of the composite material 18 is between 180 and 190° C. FIG. 5 illustrates a different perspective view of a tip of an extruder having a die 22 assembled thereon.

Referring now to FIG. 5, a flange 29 having a rectangular shape is shown. The rectangular shape of flange 29 molds and produces foamed material bearing the same shape. Accordingly, while a rectangular shape is shown, the flange 29 can possess other shapes so that different configurations of foamed materials can be produced.

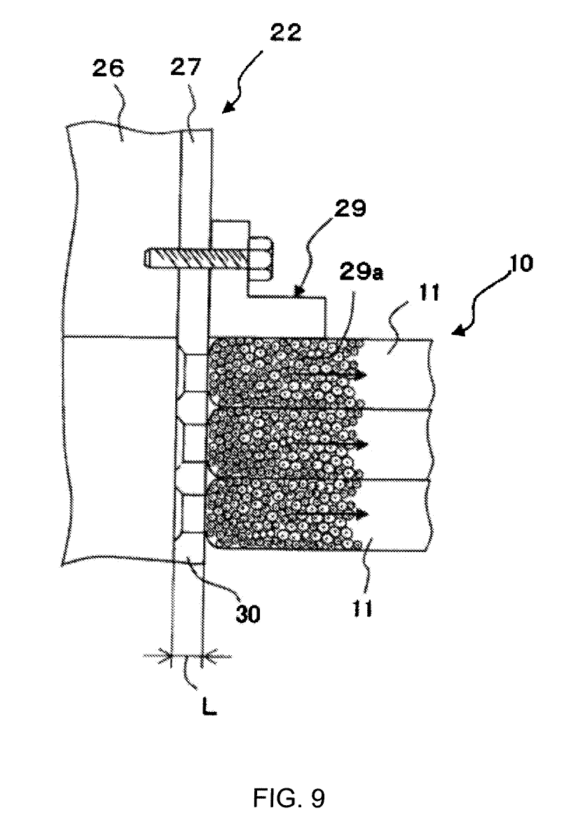

Holes 30 are arranged in X (horizontal) and Y (vertical) directions of the hole plate 27. The diameter (D) for each hole 30 can be between about 1 and 3.5 mm. In various embodiments of the present invention, the diameter (D) of the outlet end of each hole 30 is the same. In some embodiments, the internal surface 27a of hole 30 is smooth and has a consistent surface area. In other embodiments, the hole 30 is tapered such that the internal surface area of the hole 30 is larger at an inlet end facing the extruder screw and smaller at the opposite outlet end. In other words, the hole 30 is tapered with an enlarged end facing the extruder screw and a smaller opposite end (FIG. 9.) In this way, injection of the composite material through holes 30 can improve.

Still referring to FIG. 9, the length (L) of each hole 30 is between 3 and 10 mm. In one embodiment, desired pressure at the extruder cylinder 21 is achieved when the hole 30 has the dimensions within the above mentioned range. In other words, if the diameter of each hole 30 is between 1.0 and 3.5 mm and the length is between 3.0 and 10 mm, the desired vapor pressure can be achieved during the heating and mixing process of composite material 18 in the enclosed extruder cylinder 21.

In one embodiment, each hole 30 is spaced apart in the X direction (the distance between the centers of two holes on the same role) at a distance (P) between 3.0 and 10 mm. In this way, as the foamed strands 11 are being extruded out through holes 30 located nearest to the flange internal wall 29a, the foamed strands 11 are in contact with the internal wall 29a thereby taking on the shape of the molding passage 29b (FIG. 9).

Referring now to FIG. 6, a partial hole plate 27 showing a zigzag hole arrangement according to one embodiment of the present invention is shown. The hole plate 27 includes a solid plate area 27b and a plurality of holes 30 arranged in multiple rows 30(1) to 30(5). As shown in FIG. 6, the first row of holes is labeled as 30(1), the second row is labeled as 30(2), and so on. In the shown embodiment, each hole on the same row is spaced apart by a holes-separation distance (P). The first hole in the next adjacent role is offset by half the hole distance (P/2) so that the three closest holes to each other form an equilateral triangle with sides having an equal distance of P.

Referring now to FIG. 7, another hole arrangement of the hole plate 27 according to another embodiment of the present invention is shown. In this arrangement, each adjacent row has holes that are aligned to one another. The hole arrangements can be provided in numerous different ways according to the use of the foamed material. For instance, as shown in FIG. 8, the holes 30 are arranged in a random manner. Although as shown, holes 30 are aligned on rows 30(1) to 30(5) spacing at equal distance Q from each other, they need not be so. In other embodiments, holes 30 are arranged in a non-uniform fashion and are not necessarily arranged in equally spaced rows.

As previously mentioned, the hole plate 27 provides foamed strands 11 having bubbles forming therein, but the dimensions and arrangement of the hole plate can vary to achieve desired foam structures. Similarly, the shapes and dimensions of the foamed material 10 (FIG.4) can also be varied by using different flanges. FIGS. 3 and 4 show a flange 29 having an internal wall 29a and a molding passage 29b that is cubical in shape. Thus, as the composite material is extruded out through the hole plate 27 into the molding passage 29b, the composite material is pressed against the internal wall 29a of the flange 29, thereby taking on the shape of the molding passage 29b.

In one embodiment, the composite material 18 is mixed in a hopper and heated in the extruder cylinder 21 to a temperature between 155 and 195° C. As the composite material 18 is heated in the extruder cylinder 21, the vapor solution 15 evaporates thereby increasing the pressure in the extruder cylinder 21. The pressure buildup facilitates the transfer of the composite material out of the high pressure cylinder 21 and through holes 30 of the hole plate 27 to ambient condition. The vapors within the composite material expand, thereby creating foams or foamed cells within foamed strands 11.

In some embodiments, fine paper powder 12 becomes a nucleus for foaming. Membranes of foamed cells of starch 13, polypropylene 14, and vapors start to form (FIG. 9) when the composite material 18 is mixed. As the composite material 18 is expelled through the die 22 and exposed to the atmosphere through holes 30 in the hole plate 27, the vapor evaporates thereby creating vacant spaces and the vacant spaces are filled or replaced with air thereby forming foamed cells.

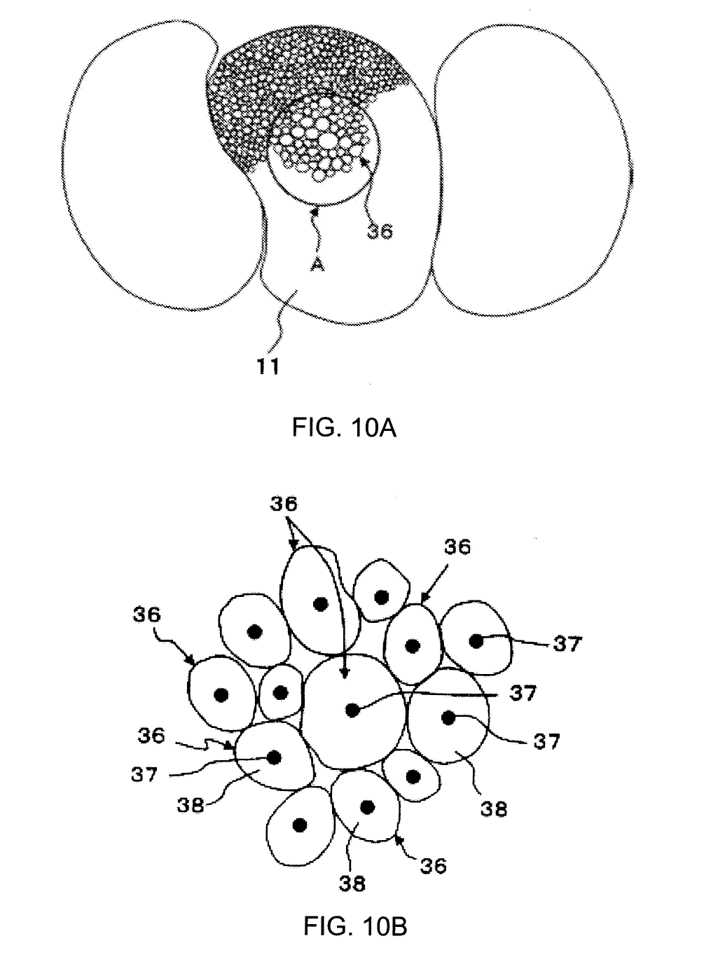

Referring now to FIGS. 10A and 10B, foamed strands 11 having a plurality of foamed cells 36 are shown. FIG. 10B is an enlarged view of a group of foamed cells 36 within a foamed strand of FIG. 10A. Fine paper powder 12 serves as the nucleus 37 so that foamed cells 36 can be formed. Foamed cells 36 include a membrane layer 38 that forms around a mixture of air, starch 13, and polypropylene 14.

In other embodiments, fibers from wood, trunk or fruit core of sugar cane, rice stem, barley trunk, etc., can also serve as nuclei 37 for foamed cells 36. A mixture of starch 13, polypropylene resin 14, and air surround the nuclei 37 with membrane layers 38. When fibers are used, consistent foamed cell sizes and fine texture in cross-section can be achieved. In addition, the strength of the foamed material may also improve.

In previously described embodiments, a 2-axis extruder is used to mix, heat, and extrude the foamed composite, but the invention is not limited to such an extruder or method.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of producing a foamed material, the method comprising:
forming a composite material comprising paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material; and
forming the foamed material from the composite material by producing an abrupt expansion of vapor in the composite material.

2. The method of claim 1, wherein the forming of the composite material comprises forming the composite material to further comprise an antioxidant being between about 0.1 and about 3.0 weight % of the composite material, boric acid being between about 1.0 and 10.0 weight % of the composite material, and a UV absorbent being between about 1.0 and 10 weight % of the composite material.

3. The method of claim 1, further comprising increasing pressure in the extruder cylinder by generating carbonate gas as at least a portion of the vapor.

4. The method of claim 3, wherein the forming of the composite material comprises forming the composite material to further comprise a calcium carbonate or sodium stannic acid material being between about 0.5 to about 15.0 weight % of the composite material.

5. The method of claim 1, wherein the vapor solution comprises water.

6. The method of claim 1, wherein the vapor solution further comprises water and alcohol, the alcohol being between about 3 and about 30 weight % of the vapor solution.

7. The method of claim 6, wherein the alcohol is between about 8 and about 35 weight % of the vapor solution.

8. The method of claim 1, wherein the forming of the composite material comprises forming the composite material to further comprise basic micro powder having a pH between about 8 and 14 and being between about 0.2 and 5.0 weight % of the composite material, the basic micro powder being selected from the group consisting of fired shells, sodium hydrates, sodium stannic acids, and combinations thereof.

9. The method of claim 1, wherein the forming of the foamed material comprises:
injecting the composite material through an extruder, and heating and kneading the composite material in an enclosed extruder cylinder of the extruder at a forming temperature between about 155 to 195° C.;
extruding and foaming a plurality of strands from the composite material and out of the extruder along one direction under pressure from holes in a die of the extruder, the foaming of the extruded strands comprising the producing of the abrupt expansion of the vapor in the composite material; and
fusing the plurality of strands together with latent heat.

10. The method of claim 9, wherein each of the holes in the die has a size between about 1.0 and about 3.5 mm on a first side of the die and a length between about 3.0 to about 10 mm from a second side of the die to the first side of the die.

11. The method of claim 9, wherein the centers of the holes on a first side of the die are separated from each other by a distance between about 4.0 and about 20 mm.

12. The method of claim 1, wherein the forming of the composite material comprises forming the composite material to further comprise a plant fiber having a length between about 50 and about 300 μm and a thickness between about 10 and about 30 μm.

13. The method of claim 12, wherein the plant fiber is composed of a fiber selected from the group consisting of wood, trunk or fruit core of sugar cane, rice stem, barley trunk, and combinations thereof.

14. A foamed material formed by a composite material comprising paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material.

15. The foamed material of claim 14, wherein the formed material comprises:
a plurality of foamed strands extending along one direction,
the composite material being kneaded with an extruder to form a dough,
the dough being extruded under pressure through holes in a die of the extruder into the plurality of foamed strands along the one direction,
the plurality of foamed strands being foamed by an abrupt expansion of vapor in the composite material, and
the plurality of foamed strands being fused together at their contact points to produce the foamed material.

16. The foamed material of claim 15, wherein each of the holes in the die has a size between about 1.0 and about 3.5 mm on a first side of the die and a length between about 3.0 to about 10 mm from a second side of the die to the first side of the die.

17. The foamed material of claim 15, wherein the centers of the holes on a first side of the die are separated from each other by a distance between about 4.0 and about 20 mm.

18. A composite material for forming a foamed material comprising paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material.

19. The composite material of claim 18, further comprising an antioxidant being between about 0.1 and about 3.0 weight % of the composite material, boric acid being between about 1.0 and 10.0 weight % of the composite material, and a UV absorbent being between about 1.0 and 10 weight % of the composite material.

20. The composite material of claim 19, further comprising a calcium carbonate or sodium stannic acid material being between about 0.5 to about 15.0 weight % of the composite material to increase pressure in the extruder by generating carbonate gas as at least a portion of the vapor.

21. The composite material of claim 18, wherein the vapor solution comprises water.

22. The composite material of claim 18, wherein the vapor solution further comprises water and alcohol, the alcohol being between about 3 and about 30 weight % of the vapor solution.

23. The composite material of claim 22, wherein the alcohol is between about 8 and about 35 weight % of the vapor solution.

24. The composite material of claim 18, further comprising basic micro powder having a pH between about 8 and 14 and being between about 0.2 and 5.0 weight % of the composite material, the basic micro powder being selected from the group consisting of fired shells, sodium hydrates, sodium stannic acids, and combinations thereof.

25. The composite material of claim 18, further comprising a plant fiber having a length between about 50 and about 300 μm and a thickness between about 10 and about 30 μm.

26. The composite material of claim 25, wherein the plant fiber is composed of a fiber selected from the group consisting of wood, trunk or fruit core of sugar cane, rice stem, barley trunk, and combinations thereof.

27. A system for producing a foamed material comprising a plurality of strands extending along one direction, the system comprising:
means for forming a composite material comprising paper powder having a maximum particle size between about 30 to about 100 μm and being between about 20 and 40 weight percent (%) of the composite material, starch powder having a maximum particle size between about 5 to about 30 μm and being between about 20 and about 40 weight % of the composite material, a polypropylene resin being between about 30.0 and 49.5 weight % of the composite material, and a vapor solution being between about 10 and about 20 weight % of the composite material;
means for injecting the composite material through an extruder, and heating and kneading the composite material in an enclosed extruder cylinder of the extruder at a forming temperature between about 155 to 195° C.;
means for extruding and foaming the plurality of strands from the composite material and out of the extruder along the one direction under pressure from holes in a die of the extruder, the means for foaming the extruded strands comprising means for producing an abrupt expansion of vapor in the composite material; and
means for forming the foamed material by fusing the plurality of strands together with latent heat.
